(19) United States
(12) Patent Application Publication
(10) Pub. No.: US 2008/0090446 A1
(43) Pub. Date: Apr. 17, 2008

(54) Peripheral device locking arrangement

(76) Inventors: Mark Lamont, Holtsville, NY (US); David M. Bauer, Head of the Harbor, NY (US); Amir Weiss, Patchogue, NY (US)

Correspondence Address: FAY KAPLUN & MARCIN, LLP, 15O BROADWAY, SUITE 702, NEW YORK, NY, 10038, US

(21) Appl. No.: 11/582,288

(22) Filed: Oct. 17, 2006

(51) Int. Cl. H01R 13/627

(52) U.S. Cl. 439/351

(57) ABSTRACT

Described is a peripheral device locking arrangement. The device comprises an attachment arrangement including a receiving assembly and a first locking mechanism, and a second locking mechanism coupled to the attachment arrangement. The receiving assembly detachably receives a peripheral device. The first locking mechanism locks the peripheral device in the receiving assembly. When the second locking mechanism is in a locked position, the second locking mechanism prevents removal of the peripheral device from the receiving assembly. The peripheral device is removable from the receiving assembly only when (i) the first locking mechanism is released and (ii) the second locking mechanism in is an unlocked position.

### FIELD OF THE INVENTION

The present invention relates generally to a locking arrangement for maintaining a connection between a peripheral device and a host device.

### BACKGROUND

Extended functionality may be provided to a mobile computing unit (MU) through the use of a peripheral device. For example, a memory card may increase storage capacity of the MU. The peripheral device is typically coupled to the MU via a connector which is readily accessible by a user, allowing the peripheral device to be easily attached to and removed from the MU. However, if the MU is dropped, shaken, etc., the peripheral device may come loose from the connector, terminating an electrical connection with the MU and any data exchange therewith which may result in loss and/or corruption of data. Thus, there is a need for a mechanism to ensure that the peripheral device remains coupled to the MU when used, carried, dropped, shaken, etc.

### SUMMARY OF THE INVENTION

The present invention relates to a peripheral device locking arrangement. The device comprises an attachment arrangement including a receiving assembly and a first locking mechanism, and a second locking mechanism coupled to the attachment arrangement. The receiving assembly detachably receives a peripheral device. The first locking mechanism locks the peripheral device in the receiving assembly. When the second locking mechanism is in a locked position, the second locking mechanism prevents removal of the peripheral device from the receiving assembly. The peripheral device is removable from the receiving assembly only when (i) the first locking mechanism is released and (ii) the second locking mechanism in is an unlocked position.

### DESCRIPTION OF THE DRAWINGS

FIG. 1 shows an exemplary embodiment of a system according to the present invention;

FIG. 2 shows an exemplary embodiment of an attachment arrangement on a host device according to the present invention;

FIG. 3 shows an exemplary embodiment of a peripheral device locking arrangement according to the present invention;

FIG. 4 shows an exemplary embodiment of a peripheral device locking arrangement according to the present invention;

FIG. 5 shows an exemplary embodiment of a method for removing a peripheral device from a peripheral device locking arrangement and an attachment arrangement of a host device according to the present invention;

FIG. 6 shows an exemplary embodiment of a peripheral device coupled to a host device according to the present invention;

FIG. 7 shows an exemplary embodiment of an attachment arrangement in an unlocked position according to the present invention; and

FIG. 8 shows an exemplary embodiment of a memory card removed from a host device according to the present invention.

### DETAILED DESCRIPTION

The present invention may be further understood with reference to the following description and the appended drawings, wherein like elements are referred to with the same reference numerals. The present invention describes a peripheral device locking arrangement for a host device. According to the exemplary embodiments of the present invention, the locking arrangement maintains a physical coupling between the peripheral device and the host device even when the host device experiences a shock event, i.e., any force which may cause the peripheral device to lost/shift from its intended physical and/or electrical connection with the host device. The shock event includes, but is not limited to, shaking, drops, transport, inadvertent removal attempts, etc. In a preferred embodiment, the locking arrangement is useful for a single motion insertion.

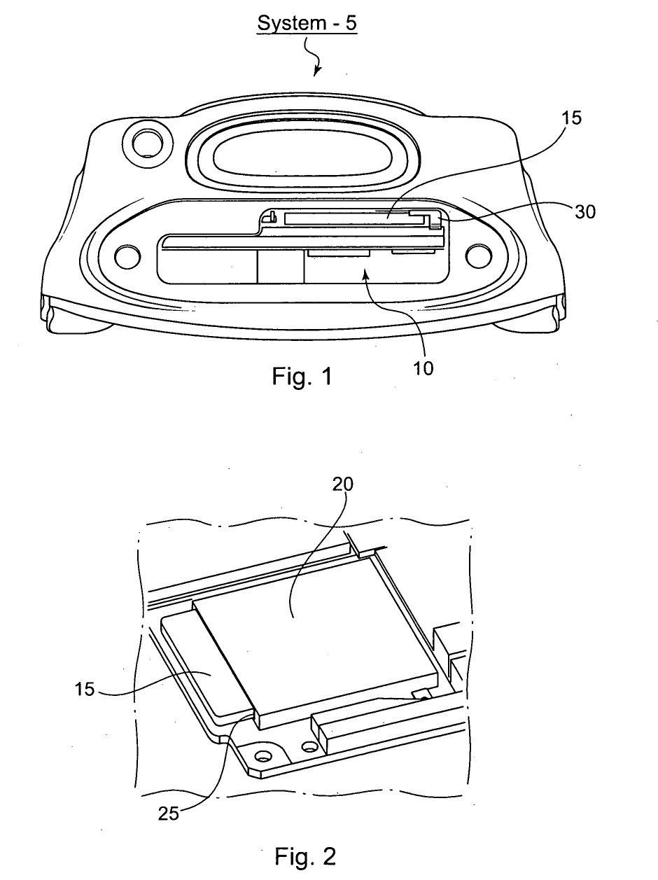

FIG. 1 shows an exemplary embodiment of a system 5 according to the present invention which includes a host device and a peripheral device physically coupled thereto. In the embodiment shown in FIG. 1, the host device is a mobile computing unit (MU) 10 which may be, for example, a laser-/imager-based scanner, an RFID reader, a mobile phone, a PDA, a digital camera, a digital media player, a tablet computer, a laptop, etc., and the peripheral device is a memory card 15 which may be, for example, a secure digital (SD) card, a micro/mini SD card, a flash card, a compact flash (CF) card, a network interface card (NIC), a memory stick, a subscriber identity module (SIM) card, a personal computer memory card international association (PCMCIA) card, integrated circuit (IC) card, etc. While the exemplary embodiment is described with reference to the MU 10 and the memory card 15, those of skill in the art will understand that the peripheral device locking arrangement according to the present invention may be utilized with any host computing (e.g., PC, game console, etc.) and any peripheral device coupleable thereto (e.g., keypad, touch screen, mouse, keyboard, display screen, magnetic stripe reader, etc.).

FIG. 2 shows an exemplary embodiment of an attachment arrangement of the MU 10 for receiving the memory card 15. The attachment arrangement includes a receiving assembly (e.g., a card slot 20) which may be mounted on a printed circuit board (PCB) or any other part of a stack assembly in the MU 10. The card slot 20 includes an opening 25 which receives the memory card 15 and electrical connectors which interface with corresponding electrical connectors on the memory card 15, allowing a processor of the MU 10 to read/write data on the memory card 15.

The card slot 20 may use utilize a locking mechanism (e.g., a conventional push-pull mechanism) to retain the memory card 15 therein. Using the push-pull mechanism, for example, the memory card 15 is inserted into the card slot 20 and engaged by a latch (or other mechanism) to retaining the memory card 15 within the card slot 20. Typically, a portion of the memory card 15 (e.g., a lagging edge) remains exposed from the card slot 20 when the memory card 15 is inserted therein. To remove the memory card 15, the memory card 15 is pushed further into the card slot 20 until the latch disengages, and the memory card 15 is ejected from the card slot 20 (typically by a spring). Other exemplary embodiments of the locking mechanism utilized by the card slot 20 include, but are not limited to, a frictional fit, a snap fit, a magnetic coupling, etc.

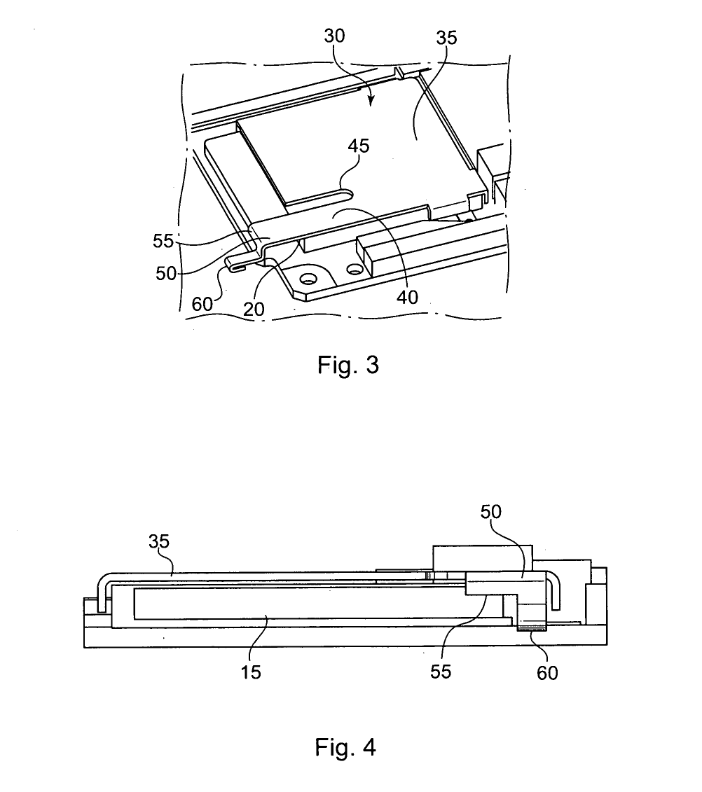

FIG. 3 shows an exemplary embodiment of a locking arrangement 30 according to the present invention. In the exemplary embodiment, the locking arrangement 30 is an overlay which is mounted over the card slot 20. Preferably, the locking arrangement 30 has a substantially similar shape as the card slot 20 and has a low profile (thin) so that a stack height in the MU 10 is not significantly altered when it is mounted on the card slot 20. The locking arrangement 30 may be manufactured as a single piece item from, for example, metal, plastic or any combination thereof.

The locking arrangement 30 generally includes a body portion 35 and an arm 40. The body portion 35 may be mounted on the card slot 20 using, for example, adhesive, double-sided tape, welding, mechanical means, etc. The body portion 35 may also be coupled to the PCB underlying the card slot 20 using similar coupling means. The body portion 35 may cover substantially all or a selected portion of the card slot 20. The more surface area of the card slot 20 that is covered by the body portion 35, the more force which will be required to move the arm 40 relative thereto, as will be described further below. That is, the body portion 35 may provide stability and leverage for the arm 40.

The arm 40 may be formed by, for example, creating a channel 45 in the body portion 35. The channel 45 separates the arm 40 from the body portion 35 allowing the arm 40 to flex relative thereto. That is, the arm 40 may bend/flex while the body portion 35 remains attached to the card slot 20. Thus, it is preferable that any adhesive, double-sided tape, etc. which is used to secure the body portion 35 to the card slot 25 is not used on the arm 40, allowing the arm 40 to be lifted from an outer surface of the card slot 20. As understood by those of skill in the art, the flexibility of the arm 40 relative to the body portion 35 may be varied by increasing/decreasing a depth with which the channel 45 is formed into the body portion 35. For example, a shallow depth of the channel 45 would limit a height which may be achieved by bending the arm 40 away from the outer surface of card slot 20.

In the exemplary embodiment, the arm 40 extends along an axis substantially parallel with and offset from a longitudinal axis of the body portion 35. However, those of skill in the art will understand that the arm 40 may be formed along the longitudinal axis of the body portion 35. The arm 40 includes a latch 50 for retaining the memory card 15 within the card slot 20. The latch 50 may be formed from a portion of the arm 40 which extends a predetermined distance past the opening 25 of the card slot 20 and includes a retaining member 55 for engaging a portion of the memory card 15 when it is received in the card slot 20. In the exemplary embodiment show in FIG. 3, the latch 50 is shown as an L-shaped member with a first leg being integral with the arm 40 and a second leg (e.g., the retaining member 55) being formed substantially perpendicular to the first leg by, for example, bending a portion of the first leg.

The retaining member 55 only engages a portion (e.g., the lagging edge) of the memory card 15. However, those of skill in the art will understand that the arm 40, the latch 50 and/or the retaining member 55 may have various dimensions to engage a selected portion of the memory card 15. For example, the arm 40 and the latch 50 may be formed so that the retaining member 55 engages the entire lagging edge of the memory card 15, or there may be embodiments with more than one arm 40, latch 50 and/or retaining member 55 which are independently movable or chain-linked to move simultaneously. In addition, while FIG. 3 shows the arm 40 in contact with the outer surface of the card slot 20, in other exemplary embodiments the arm 40 may be positioned on a side surface of the card slot 20. In yet another exemplary embodiment, the locking arrangement 30 may simply include the arm 40 and/or the arm 40 may be formed integrally with the card slot 20.

The arm 40 may further include a handle 60 coupled to the latch 50 allowing a user to disengage the retaining member 55 from the memory card 15. The handle 60 may be offset from the opening 25 of the card slot 20 so that the handle 60 does not obstruct access to the card slot 20. In the exemplary embodiment, the handle 60 is an L-shaped member with a first leg attached to the retaining member 55 and a second leg extending (in a direction opposite the card slot 20) a predetermined distance substantially perpendicularly from the first leg so that a user may easily manipulate the arm 40 by interfacing with the handle 60. The second leg of the handle 60 may be folded over or otherwise formed (e.g., rounded interface, include a bumper/cover, etc.) so that a sharp edge is not presented to the user.

FIG. 4 shows an exemplary embodiment of the retaining member 55 engaging the memory card 15. The handle 60 is coupled to a lateral portion of the retaining member 55 providing a clearance area which allows the memory card 15 to be removed from the card slot 20 after it has been disengaged from the retaining member 55 as described below. The size/shape of the retaining member 55 and clearance area may be variable to vary a surface contacting percentage between the lagging edge of the memory card 15 and the retaining member 55 of the latch 50.

In the exemplary embodiments, the arm 40 is biased to a locked position in which the retaining member 55 is positioned over a portion of the opening 25 of the card slot 20. However, in other exemplary embodiments, the retaining member 55 may require a user to move the retaining member 55 between the locked and unlocked positions. In the locked position, the arm 40 contacts the outer surface of the card slot 20 along an entire length of the arm 40 up to the latch 50, which extends past the card slot 20. Thus, to insert the memory card 15 into the card slot 20, a leading edge of the memory card 15 may be inserted into the opening 25 while angling the memory card 15 to prevent contact with the retaining member 55. As the memory card 15 is inserted into the card slot 20, the memory card 15 (or the user) may displace the retaining member 55, allowing the memory card 15 to be received within the card slot 20. Displacing the retaining member 55 causes the arm 40 to flex away from the outer surface of the card slot 20 into an unlocked position. When the lagging edge of the memory card 15 has passed the retaining member 55, the bias of the arm 40 causes the retaining member 55 to snap over the lagging edge of the memory card 15 back into the locked position, thereby preventing removal from the card slot 20.

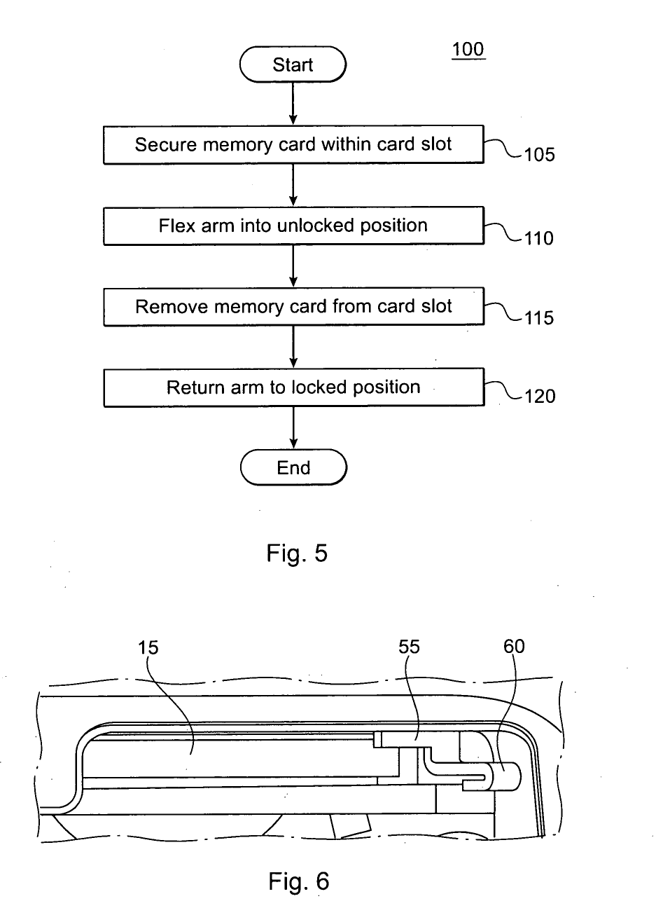

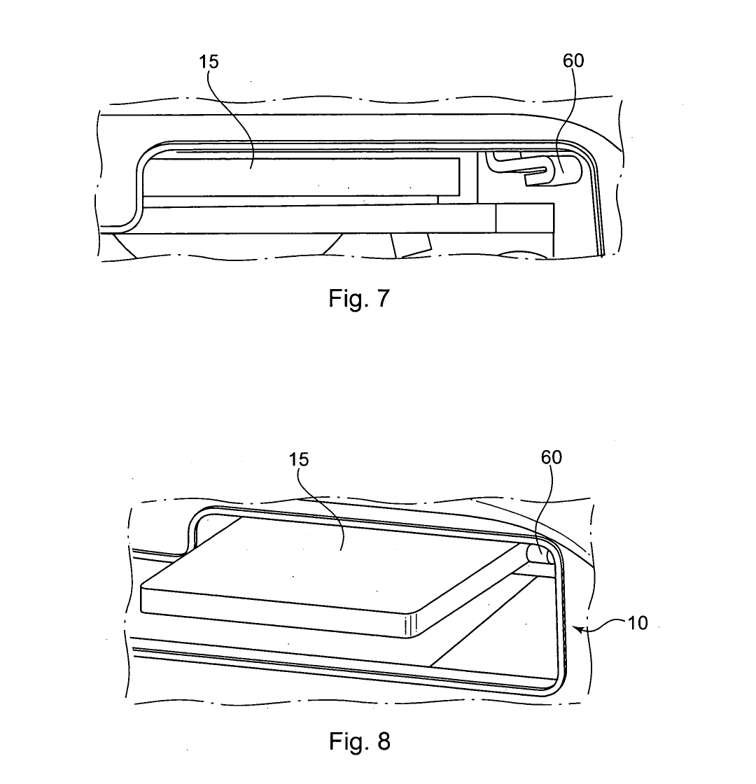

FIGS. 5 shows an exemplary embodiment of a method 100 for removing the memory card 15 from the card slot 20, and the steps of the method are schematically shown in FIGS. 6-8. In step 105, the memory card 15 is secured within the card slot 20 and the retaining member 55 engages the lagging edge of the memory card 15, as shown in FIG. 6. In step 110, the handle 60 is used to flex the arm 40 into the unlocked position, disengaging the retaining member 55 from the lagging edge of the memory card 15, as shown in FIG. 7. In step 115, the memory card 15 may be pulled or slid from the card slot 20. However, the card slot 20 may also utilize the conventional push-pull mechanism. Thus, the user may push the lagging edge of the memory card 15 further into the card slot 20 to disengage the push-pull mechanism and have the memory card 15 ejected from the card slot 20. Because user is maintaining the arm 40 in the unlocked position and the latch 50 includes the clearance area between the handle 60 and the retaining member 55, the memory card 15 may be removed from the card slot 20, as shown in FIG. 8. In step 120, the arm 40 returns to the locked position when the user stops applying force to the handle 60.

From the above description, those of skill in the art will understand that the present invention may prevent dislodging of a peripheral device when the host device it is coupled to experiences a shock event. Maintaining a physical and electrical coupling during the shock event ensures an integrity of data exchange between the peripheral device and the host device. Thus, the present invention may increase ruggedness of the host device and improve user satisfaction therewith.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
an attachment arrangement including a receiving assembly and a first locking mechanism, the receiving assembly detachably receiving a peripheral device, the first locking mechanism locking the peripheral device in the receiving assembly; and
a second locking mechanism coupled to the attachment arrangement, when the second locking mechanism is in a locked position, the second locking mechanism prevents removal of the peripheral device from the receiving assembly,
wherein the peripheral device is removable from the receiving assembly only when (i) the first locking mechanism is released and (ii) the second locking mechanism in is an unlocked position.

2. The device according to claim 1, wherein the second locking mechanism must be in the unlocked position to release the peripheral device from the first locking mechanism.

3. The device according to claim 1, wherein the receiving assembly is one of a card slot, a USB port and a serial connector.

4. The device according to claim 1, wherein the first locking mechanism is one of a mechanical lock and a magnetic lock.

5. The device according to claim 1, wherein the first locking mechanism is a push-pull mechanism.

6. The device according to claim 1, wherein the peripheral device is one of a secure digital card, a flash card, a compact flash card, a subscriber identity module card, a network interface card, a personal computer memory card international association card and a memory stick.

7. The device according to claim 1, wherein the second locking mechanism includes an arm which, when in the locked position, engages at least a portion of the peripheral device exposed from the receiving assembly.

8. The device according to claim 7, wherein the arm is coupled to an overlay mounted on the receiving assembly.

9. The device according to claim 8, wherein the arm is one of flexibly and hingedly coupled to the overlay allowing the arm to be displaced from the receiving assembly.

10. The device according to claim 9, wherein, when the arm is displaced from the receiving assembly, the second locking mechanism is in the unlocked position.

11. A locking arrangement, comprising:
a receiving assembly detachably receiving a peripheral device;
a first locking mechanism locking the peripheral device in the receiving assembly; and
a second locking mechanism locking the peripheral device in the receiving assembly so that when the first locking mechanism is in an unlocked state, the peripheral device remains locked in the receiving assembly by the second locking mechanism.

12. The locking arrangement according to claim 11, wherein the peripheral device is removable from the receiving assembly only when (i) the first locking mechanism is in the unlocked state and (ii) the second locking mechanism in is an unlocked position.

13. The locking arrangement according to claim 11, wherein the receiving assembly is one of a card slot, a USB port and a serial connector.

14. The locking arrangement according to claim 11, wherein the first locking mechanism is one of a mechanical lock and a magnetic lock.

15. The locking arrangement according to claim 11, wherein the first locking mechanism is a push-pull mechanism.

16. The locking arrangement according to claim 11, wherein the peripheral device is one of a secure digital card, a flash card, a compact flash card, a subscriber identity module card, a network interface card, a personal computer memory card international association card and a memory stick.

17. A device, comprising:
a card slot detachably receiving an integrated circuit card, the card slot utilizing a first locking mechanism to lock the card therein; and
a second locking mechanism coupled to the card slot, the second locking mechanism including an arm which, when in the card is in the card slot, locks the card within the card slot.

18. The device according to claim 17, wherein the card is removable from the card slot only when (i) the first locking mechanism is released and (ii) the arm is disengaged from the card.

19. The device according to claim 17, wherein the first locking mechanism is a push-pull mechanism.

20. The device according to claim 17, wherein, when the card is within the card slot, the arm engages a portion of the card exposed from the card slot.

21. A device, comprising:
an attachment means including a receiving means and a first locking means, the receiving means detachably receiving a peripheral device, the first locking means locking the peripheral device in the receiving means; and
a second locking means coupled to the attachment means, when the second locking means is in a locked position, the second locking means prevents removal of the peripheral device from the receiving means,
wherein the peripheral device is removable from the receiving means only when (i) the first locking means is released and (ii) the second locking means in is an unlocked position.
